(19) United States
(12) Patent Application Publication
(10) Pub. No.: US 2025/0124550 A1
(43) Pub. Date: Apr. 17, 2025

(54) METHOD FOR PROCESSING LOW RESOLUTION DEGRADED IMAGE, SYSTEM, STORAGE MEDIUM, AND DEVICE THEREFOR

(71) Applicant: NANJING UNIVERSITY OF POSTS AND TELECOMMUNICATIONS, Nanjing (CN)

(72) Inventors: Dengyin ZHANG, Nanjing (CN); Weidan YAN, Nanjing (CN); Can CHEN, Nanjing (CN); Junhao YING, Nanjing (CN); Qunjian DU, Nanjing (CN); Yi LIU, Nanjing (CN)

(21) Appl. No.: 18/680,317

(22) Filed: May 31, 2024

(30) Foreign Application Priority Data
Oct. 16, 2023 (CN) 202311333485.1

(51) Int. Cl. G06T 5/60; G06T 3/4053

(52) U.S. Cl. CPC G06T 5/60; G06T 3/4053

(57) ABSTRACT

A method for processing low resolution degraded image, a system, a storage medium, and a device therefor are provided. The present disclosure adopts a dual branch processing model, which includes an image restoration branch and an image super-resolution branch. At the same time, a fusion module is used to fuse and learn image features from the two domains, thereby improving the problem of error accumulation and high computational cost caused by the two-stage processing method.

### CROSS-REFERENCE TO RELATED APPLICATIONS

This application further claims to the benefit of priority from Chinese Application No. 202311333485.1 with a filing date of Oct. 16, 2023, the content of the aforementioned applications, including any intervening amendments thereto, are incorporated herein by reference.

### TECHNICAL FIELD

The present disclosure relates to a method for processing a low resolution degraded image, system, storage medium, and device therefor, relating to the technical field of image processing.

### BACKGROUND

With the rapid development of science and technology, video images have become the main carrier of information presentation and dissemination today. High quality clear images not only have rich visual perception effects, but also have stronger information carrying capacity, providing a more solid guarantee for the development of computer vision. Especially in the field of artificial intelligence, there is an increasing demand for image quality from various aspects, such as smart cities, autonomous driving, monitoring and security, medical imaging, and entertainment. A high-quality and clear image will benefit a large number of image-based intelligent technologies, such as semantic segmentation, instance segmentation, object detection, image inpainting, etc. In recent years, with the emergence of new equipment such as unmanned systems and mobile devices, achieving dynamic perception and understanding in complex environments requires high-quality and high-resolution images as a prerequisite. However, in real-world scenarios, due to imaging environment, broadband limitations, and the influence of imaging equipment, captured images often have low resolution and are subject to various types and degrees of degradation, such as blurring and noise. This not only affects the viewing effect, but also reduces the performance of related visual tasks.

At present, the methods for unifying degraded image restoration and super-resolution mainly adopt a two-stage processing approach: first restoring degraded images and then performing super-resolution reconstruction, or first performing super-resolution reconstruction and then conducting restoration. The above approach not only leads to the accumulation of errors in two different tasks, but also increases the computational cost of the method due to repeated feature calculations.

### SUMMARY

The present disclosure provides a method for processing a low resolution degraded image, a system, a storage medium, and a device therefor, which solves the problems disclosed in background.

In order to solve the above-mentioned technical problems, the technical solution adopted by the present disclosure is:
A method for processing a low resolution degraded image, including,
Obtaining a low resolution degraded image to be processed;
Inputting the low resolution degraded image into a pre trained processing model to obtain a high-resolution clear image; wherein, the processing model includes an image restoration branch, an image super-resolution branch, and a plurality of fusion modules; the image restoration branch is used to restore the low resolution degraded image into corresponding a low resolution clear image; the image super-resolution branch is used to generate a corresponding high-resolution clear image from the low resolution degraded image; the fusion module is used to fuse image features generated during a restoration task processed by the image restoration branch and corresponding image features generated during a super-resolution task processed by the image super-resolution branch to obtain fused features, and the fused features assist in generating the high-resolution clear image.

The image restoration branch includes N restoration convolution modules, a connection module, and N restoration convolution modules sequentially connected; the image super-resolution branch includes 2N+1 super-resolution convolution modules sequentially connected, wherein the restoration convolution module is a basic operation module that uses convolution operations for restoration tasks, and the super-resolution convolution module is a basic operation module that uses convolution operations for super-resolution tasks;

The i-th fusion module concatenates output features of the i-th module in the image restoration branch, output features of the i-th module in the image super-resolution branch, and output features of the i−1-th fusion module; the concatenated features iterate a preset number of times, and the iteration result is used as the input of the i+1-th fusion module, the input of the i+1-th module in the image restoration branch, and the input of the i+1-th module in the image super-resolution branch, wherein each iteration process involves passing the features through a first convolutional layer, an activation layer, and a second convolutional layer at once; the first fusion module concatenates the output features of the first restoration convolution module, the output features of the first super-resolution convolution module, and the features of the low resolution degraded image.

The image restoration branch is an encoding and decoding structure, further including N−1 2× down-sampling module and N−1 2× up-sampling module; an encoder consists of the N restoration convolution modules and the N−1 2× down-sampling modules, and the N restoration convolution modules and the N−1 2× down-sampling modules are alternately connected in the encoder; an encoder consists of the N restoration convolution modules and the N−1 2× up-sampling modules, and the N restoration convolution modules and the N−1 2× up-sampling modules are alternately connected in the encoder; and during a decoding process, each decoding layer is connected to the feature map of the corresponding encoding layer.

The restoration convolution module includes N residual convolution modules sequentially connected.

The image super-resolution branch is a classical super-resolution structure, including a feature extraction module, a nonlinear mapping learning module, and a reconstruction module that are sequentially connected; the feature extraction module includes a convolutional layer; 2N+1 super-resolution convolution modules sequentially connected form the nonlinear mapping learning module; and the reconstruction module includes N−1 2× up-sampling modules sequentially connected.

The super-resolution convolution module includes N residual convolution modules sequentially connected.

A system for processing a low resolution degraded image, including:
An image acquisition module, configured to obtain a low resolution degraded image to be processed;
A processing module, configured to input the low resolution degraded image into a pre trained processing model to obtain a high-resolution clear image, wherein the processing model includes an image restoration branch, an image super-resolution branch, and a plurality of fusion modules; the image restoration branch is used to restore the low resolution degraded image into corresponding a low resolution clear image; the image super-resolution branch is used to generate a corresponding high-resolution clear image from the low resolution degraded image; the fusion module is used to fuse image features generated during a restoration task processed by the image restoration branch and corresponding image features generated during a super-resolution task processed by the image super-resolution branch to obtain fused features, and the fused features assist in generating the high-resolution clear image.

In the processing module, the image restoration branch includes N restoration convolution modules, a connection module, and N restoration convolution modules sequentially connected; the image super-resolution branch includes 2N+1 super-resolution convolution modules sequentially connected, wherein the restoration convolution module is a basic operation module that uses convolution operations for restoration tasks, and the super-resolution convolution module is a basic operation module that uses convolution operations for super-resolution tasks;

The i-th fusion module concatenates output features of the i-th module in the image restoration branch, output features of the i-th module in the image super-resolution branch, and output features of the i−1-th fusion module; the concatenated features iterate a preset number of times, and the iteration result is used as the input of the i+1-th fusion module, the input of the i+1-th module in the image restoration branch, and the input of the i+1-th module in the image super-resolution branch, wherein each iteration process involves passing the features through a first convolutional layer, an activation layer, and a second convolutional layer at once; the first fusion module concatenates the output features of the first restoration convolution module, the output features of the first super-resolution convolution module, and the features of the low resolution degraded image.

A computer-readable storage medium that one or more programs are stored therein, wherein the one or more programs includes instructions, and the computing device executes the method for processing a low resolution degraded image when the instructions are executed by a computing device.

A computing device, including one or more processors, a memory, and one or more programs, wherein the one or more programs are stored in the memory and configured to be executed by the one or more processors, and the one or more programs including instructions for executing the method for processing a low resolution degraded image.

The advantageous effects achieved by the present disclosure: The present disclosure adopts a dual branch processing model, which includes the image restoration branch and the image super-resolution branch. At the same time, the fusion module is used to fuse and learn the image features of the two domains, thereby improving the problem of error accumulation and high computational cost caused by the two-stage processing method.

### BRIEF DESCRIPTION OF THE DRAWINGS

FIG. 1 is a flowchart of a method for processing low resolution degraded images;

FIG. 2 is a schematic diagram of the structure of a processing model;

FIG. 3 is a schematic diagram of the structure of an image restoration branch;

FIG. 4 is a schematic diagram of the structure of the image super-resolution branch;

FIG. 5 is a schematic diagram of the structure of the fusion module.

### DETAILED DESCRIPTION OF THE EMBODIMENTS

The present disclosure will be further described in conjunction with the accompanying drawings. The following embodiments are only intended to provide a clearer illustration of the technical solution of the present disclosure and cannot be used to limit the scope of the present disclosure.

As shown in FIG. 1, a method for processing a low resolution degraded image is provided, which includes the following steps:
Step 1, obtaining a low resolution degraded image to be processed;
Step 2, inputting the low resolution degraded image into a pre trained processing model to obtain a high-resolution clear image; wherein, the processing model includes an image restoration branch, an image super-resolution branch, and a plurality of fusion modules; the image restoration branch is used to restore the low resolution degraded image into corresponding a low resolution clear image; the image super-resolution branch is used to generate a corresponding high-resolution clear image from the low resolution degraded image; the fusion module is used to fuse image features generated during a restoration task processed by the image restoration branch and corresponding image features generated during a super-resolution task processed by the image super-resolution branch to obtain fused features, and the fused features assist in generating the high-resolution clear image.

The above method adopts a dual branch processing model, which includes the image restoration branch and the image super-resolution branch. At the same time, the fusion module is used to fuse and learn the image features of the two domains, thereby improving the problem of error accumulation and high computational cost caused by the two-stage processing method.

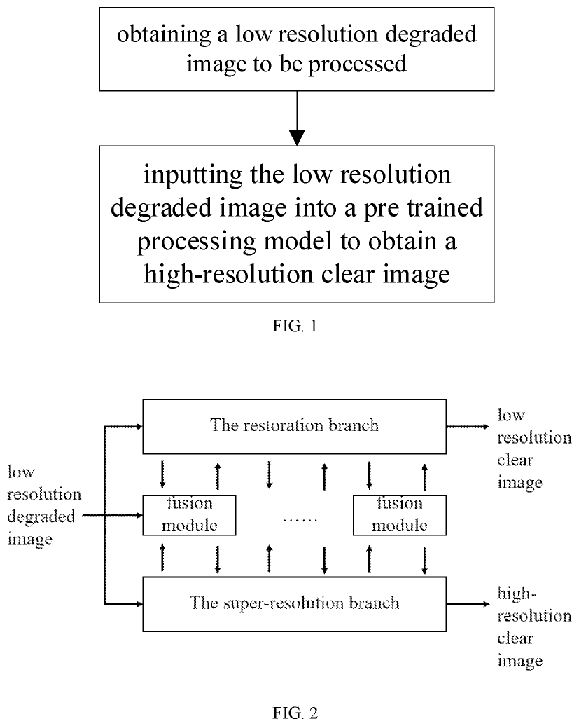

Due to the two-stage processing method, which involves accumulating errors and high computational costs when using a separate sequential model for processing, a parallel processing model can be constructed. The constructed model is shown in FIG. 2, including an image restoration branch, an image super-resolution branch, and a plurality of fusion modules. The image restoration branch is used to restore the low resolution degraded image into corresponding a low resolution clear image; the image super-resolution branch is used to generate a corresponding high-resolution clear image from the low resolution degraded image; the fusion module is used to fuse image features generated during a restoration task processed by the image restoration branch and corresponding image features generated during a super-resolution task processed by the image super-resolution branch to obtain fused features, and the fused features assist in generating the high-resolution clear image. Wherein, the entire processing model inputs low resolution degraded images, the image restoration branch can output low resolution clear images, and the image super-resolution branch can output high resolution clear images. Of course, in practical application, only high-resolution clear images are needed.

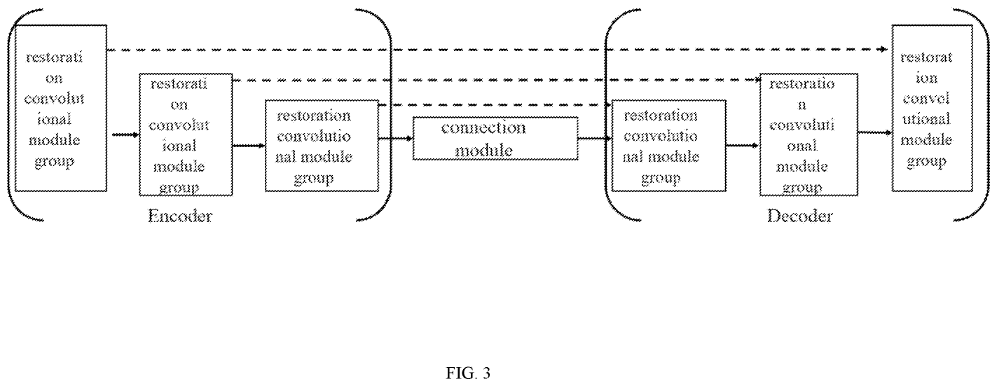

As shown in FIG. 3, the image restoration branch can adopt an encoding and decoding structure, which can effectively capture contextual information, facilitate image restoration, and grasp rich semantic information, including an encoder, a connection module, and a decoder, which are sequentially connected. The encoder transfers the image level input to the feature level representation, the connection module uses the feature representation for efficient learning, and the decoder transfers the processed feature level representation to the image level output. The encoder includes N restoration convolution modules and N−1 2× down-sampling modules, wherein N is 3. In the encoder, the restoration convolution modules and 2× down-sampling modules are alternately connected. The connection module includes 5 residual convolution modules that are sequentially connected. The decoder includes 3 restoration convolution modules and two 2× up-sampling modules corresponding to the encoder. The restoration convolution modules and 2× up-sampling modules are alternately connected in the encoder. During the decoding process, each decoding layer is connected to the feature map of the corresponding encoding layer.

The restoration convolution module includes 3 residual convolution modules that are sequentially connected. The residual convolution module consists of two convolutional layers, the input features are respectively fed into two convolutional layers, and then the resulting features are added to the input features as module outputs. The down-sampling module consists of a convolutional layer with a convolutional kernel size of 2 and a step size of 2, while the up-sampling module includes one convolutional layer with a convolutional kernel size of 1 and one sub-pixel layer with a 2× up-sampling sequentially connected.

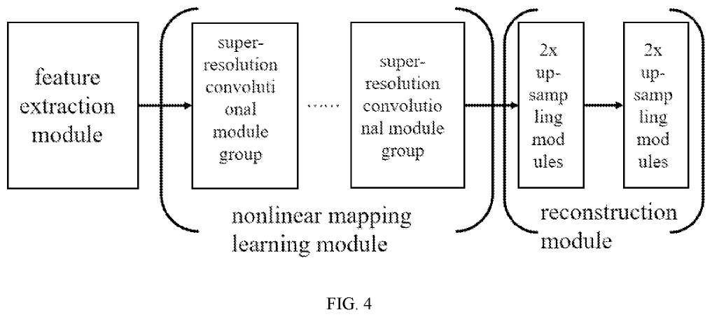

As shown in FIG. 4, the image super-resolution branch is a classical super-resolution structure that can learn precise spatial mapping relationships, which is beneficial for preserving accurate spatial information in image super-resolution. It includes feature extraction modules, non-linear mapping learning modules, and reconstruction modules, which are sequentially connected. The feature extraction module extracts feature representations from the input image, while the non-linear mapping learning module performs non-linear mapping learning on the image features. The reconstruction module uses the learned image features to reconstruct the desired output image. The feature extraction module includes one convolutional layer, the nonlinear mapping learning module includes 7 super-resolution convolution modules sequentially connected, the super-resolution convolution module specifically includes 3 residual convolution modules sequentially connected, and the reconstruction module includes two 2× up-sampling modules sequentially connected.

The fusion module corresponds to the restoration convolution module/the connection module and the super-resolution convolution module. Assuming that only the restoration convolution modules and the connection modules in the image restoration branch are labeled as 1-7, respectively, only the super-resolution convolution modules in the image super-resolution branch are labeled as 1-7. Defining that 1≤i≤7, the i-th restoration convolution module/connection module in the image restoration branch is collectively referred to as the i-th module in the image restoration branch, and the i-th super-resolution convolution module in the image super-resolution branch is collectively referred to as the i-th module in the image super-resolution branch.

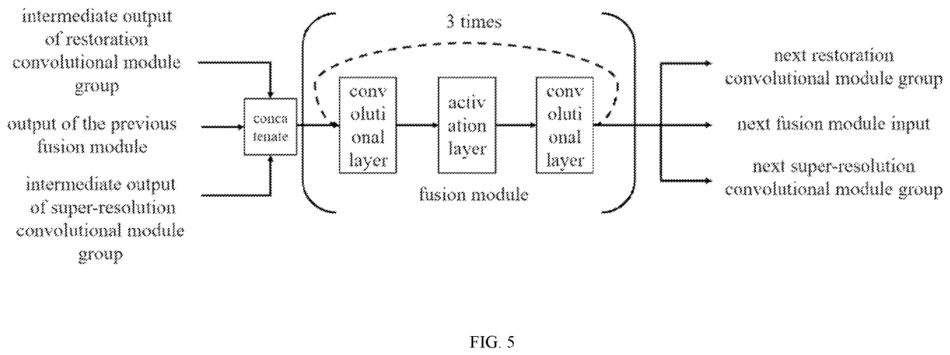

Thus, it can be seen from the FIG. 5, the i-th fusion module concatenates the output features of the i-th module in the image restoration branch, the output features of the i-th module in the image super-resolution branch, and the output features of the i−1-th fusion module. The concatenated features iterate a preset number of times, and the iteration result is used as the input of the i+1-th fusion module, the input of the i+1-th module in the image restoration branch, and the input of the i+1-th module in the image super-resolution branch, wherein each iteration process involves passing the features through a first convolutional layer, an activation layer, and a second convolutional layer at once; the first fusion module concatenates the output features of the first restoration convolution module, the output features of the first super-resolution convolution module, and the features of the low resolution degraded image.

The fusion module iteratively runs, efficiently integrating features from both restoration and super-resolution domains, avoiding duplicate feature calculations, and adaptively utilizing features from different domains to promote learning and improve network performance.

Based on the structure of the processing model, the loss function of the model can be L=L_{Restore}+L_{Reconstruct}, wherein L_{Restore} is the restoration loss, L_{Reconstruct} is the super-resolution reconstruction loss, and both use L1 loss, which can be expressed as:

$${L}_{Restore} = {\vert lx - \vert}_{1}$$

$${L}_{Reconstruct} = {\vert hx - \vert}_{1}$$

In the formula, [symbol] , lx, [symbol] , and hx are respectively the low resolution clear image output by the network, the ground-truth label representing the low resolution clear image, the high resolution clear image output by the network, and the ground-truth label representing the high resolution clear image.

Further training of the above model can be achieved by first obtaining a degraded image dataset (GOPRO dataset), with fuzzy degradation as the main type of data degradation. This dataset is downloaded from existing publicly available image databases, and then obtaining paired high-resolution degraded images (DegHR) and their corresponding high-resolution clear images (SharpHR) from the degraded image dataset (GOPRO dataset). The high-resolution degraded images and the high-resolution clear images are down-sampled s times to obtain low resolution degraded images and low resolution clear images, and down-sampled s times using bicubic interpolation method, and the value of s is 4 corresponding to a 4× super-resolution task. The low resolution degraded images (DegLR), the low resolution clear images (SharpLR), and the high-resolution degraded images (DegHR) are used as training datasets for the processing model. During training, the gradient descent method can be used to continuously train the model, and the Adam optimizer can be used to assist in parameter learning. When the loss function is minimized, training can be stopped to obtain the trained processing module.

Further, inputting a low resolution degraded image into the pre trained processing model can obtain a high-resolution clear image. The present disclosure adopts an end-to-end modeling approach to avoid the accumulation of errors and additional computational costs caused by two-stage methods. It also proposes a fusion module for iterative mining and learning of features from two different domains in the dual branch, effectively combining rich contextual semantic information with accurate spatial mapping information, improving the indicator scores of existing methods, and enriching visual details.

Based on the same technical solution, the present disclosure also discloses a software system corresponding to the above method, a system for processing a low resolution degraded image, including:
An image acquisition module, configured to obtain a low resolution degraded image to be processed;
A processing module, configured to input the low resolution degraded image into a pre trained processing model to obtain a high-resolution clear image, wherein the processing model includes an image restoration branch, an image super-resolution branch, and a plurality of fusion modules; the image restoration branch is used to restore the low resolution degraded image into corresponding a low resolution clear image; the image super-resolution branch is used to generate a corresponding high-resolution clear image from the low resolution degraded image; the fusion module is used to fuse image features generated during a restoration task processed by the image restoration branch and corresponding image features generated during a super-resolution task processed by the image super-resolution branch to obtain fused features, and the fused features assist in generating the high-resolution clear image.

In the processing module, the image restoration branch includes N restoration convolution modules, a connection module, and N restoration convolution modules, which are sequentially connected; the image super-resolution branch includes 2N+1 super-resolution convolution modules sequentially connected, wherein the restoration convolution module is a basic operation module that uses convolution operations for restoration tasks, and the super-resolution convolution module is a basic operation module that uses convolution operations for super-resolution tasks;

The i-th fusion module concatenates output features of the i-th module in the image restoration branch, output features of the i-th module in the image super-resolution branch, and output features of the i−1-th fusion module; the concatenated features iterate a preset number of times, and the iteration result is used as the input of the i+1-th fusion module, the input of the i+1-th module in the image restoration branch, and the input of the i+1-th module in the image super-resolution branch, wherein each iteration process involves passing the features through a first convolutional layer, an activation layer, and a second convolutional layer at once; the first fusion module concatenates the output features of the first restoration convolution module, the output features of the first super-resolution convolution module, and the features of the low resolution degraded image.

The above method adopts a dual branch processing model, which includes the image restoration branch and the image super-resolution branch. At the same time, the fusion module is used to fuse and learn the image features of the two domains, thereby improving the problem of error accumulation and high computational cost caused by the two-stage processing method.

Based on the same technical solution, the present disclosure also discloses a computer-readable storage medium that stores one or more programs, wherein the one or more programs includes instructions. When the instructions are executed by a computing device, causing the computing device to perform a low resolution degraded image processing method.

Based on the same technical solution, the present disclosure also discloses a computing device, which includes one or more processors, a memory, and one or more programs, wherein one or more programs are stored in the memory and configured to be executed by the one or more processors, and the one or more programs include instructions for executing the low resolution degraded image processing method.

The skilled person in the art should understand that embodiments of this application may be provided as methods, systems, or computer program products. Therefore, this application may take the form of a complete hardware embodiment, a complete software embodiment, or a combination of software and hardware embodiments. Moreover, this application may take the form of a computer program product implemented on one or more computer available storage media (including but not limited to disk storage, CD-ROM, optical storage, etc.) containing computer available program codes.

This disclosure is described with reference to the flowchart and/or block diagram of the method, device (system), and computer program product according to the embodiments of this disclosure. It should be understood that each process and/or block in the flowchart and/or block diagram can be implemented by computer program instructions, as well as the combination of processes and/or blocks in the flowchart and/or block diagram. These computer program instructions can be provided to processors of general-purpose computers, specialized computers, embedded processors, or other programmable data processing devices to generate a machine that generates instructions executed by processors of computers or other programmable data processing devices to implement the functions specified in one or more processes and/or blocks in a flowchart.

These computer program instructions can also be stored in computer-readable memory that can guide computers or other programmable data processing devices to work in a specific way, so that the instructions stored in the computer-readable memory generate a manufacturing product including an instruction device that implements the functions specified in one or more processes and/or blocks of a flowchart.

These computer program instructions can also be loaded onto computers or other programmable data processing devices to perform a series of operational steps on the computer or other programmable devices to generate computer-implemented processing, so that the instructions executed on the computer or other programmable devices provide steps for implementing the functions specified in one or more processes and/or blocks in a flowchart.

The above is only an embodiment of the present disclosure, not intended to limit it. Any modifications, equivalent substitutions, improvements, etc. made within the spirit and principles of the present disclosure are included within the scope of the claims of the disclosure pending approval.

What is claimed is:

1. A method for processing a low resolution degraded image, comprising,
obtaining a low resolution degraded image to be processed;
inputting the low resolution degraded image into a pre trained processing model to obtain a high-resolution clear image; wherein, the processing model comprises an image restoration branch, an image super-resolution branch, and a plurality of fusion modules; the image restoration branch is used to restore the low resolution degraded image into corresponding a low resolution clear image; the image super-resolution branch is used to generate a corresponding high-resolution clear image from the low resolution degraded image; the fusion module is used to fuse image features generated during a restoration task processed by the image restoration branch and corresponding image features generated during a super-resolution task processed by the image super-resolution branch to obtain fused features, and the fused features assist in generating the high-resolution clear image.

2. The method for processing a low resolution degraded image according to claim 1, wherein the image restoration branch comprises N restoration convolution modules, a connection module, and N restoration convolution modules, and the N restoration convolution modules, the connection module, and the N restoration convolution modules are sequentially connected; the image super-resolution branch comprises 2N+1 super-resolution convolution modules sequentially connected, wherein the restoration convolution module is a basic operation module that uses convolution operations for restoration tasks, and the super-resolution convolution module is a basic operation module that uses convolution operations for super-resolution tasks;
the i-th fusion module concatenates output features of the i-th module in the image restoration branch, output features of the i-th module in the image super-resolution branch, and output features of the i−1-th fusion module; the concatenated features iterate a preset number of times, and the iteration result is used as the input of the i+1-th fusion module, the input of the i+1-th module in the image restoration branch, and the input of the i+1-th module in the image super-resolution branch, wherein each iteration process involves passing the features through a first convolutional layer, an activation layer, and a second convolutional layer at once; the first fusion module concatenates the output features of the first restoration convolution module, the output features of the first super-resolution convolution module, and the features of the low resolution degraded image.

3. The method for processing a low resolution degraded image according to claim 2, wherein the image restoration branch is an encoding and decoding structure, further comprising N−1 2× down-sampling module and N−1 2× up-sampling module; an encoder consists of the N restoration convolution modules and the N−1 2× down-sampling modules, and the N restoration convolution modules and the N−1 2× down-sampling modules are alternately connected in the encoder; an encoder consists of the N restoration convolution modules and the N−1 2× up-sampling modules, and the N restoration convolution modules and the N−1 2× up-sampling modules are alternately connected in the encoder; and during a decoding process, each decoding layer is connected to the feature map of the corresponding encoding layer.

4. The method for processing a low resolution degraded image according to claim 3, wherein the restoration convolution module comprises N residual convolution modules sequentially connected.

5. The method for processing a low resolution degraded image according to claim 2, wherein the image super-resolution branch is a classical super-resolution structure, comprising a feature extraction module, a nonlinear mapping learning module, and a reconstruction module that are sequentially connected; the feature extraction module comprises a convolutional layer; 2N+1 super-resolution convolution modules sequentially connected form the nonlinear mapping learning module; and the reconstruction module comprises N−1 2× up-sampling modules sequentially connected.

6. The method for processing a low resolution degraded image according to claim 5, wherein the super-resolution convolution module comprises N residual convolution modules sequentially connected.

7. A system for processing a low resolution degraded image, comprising:
an image acquisition module, configured to obtain a low resolution degraded image to be processed;
a processing module, configured to input the low resolution degraded image into a pre trained processing model to obtain a high-resolution clear image, wherein the processing model comprises an image restoration branch, an image super-resolution branch, and a plurality of fusion modules; the image restoration branch is used to restore the low resolution degraded image into corresponding a low resolution clear image; the image super-resolution branch is used to generate a corresponding high-resolution clear image from the low resolution degraded image; the fusion module is used to fuse image features generated during a restoration task processed by the image restoration branch and corresponding image features generated during a super-resolution task processed by the image super-resolution branch to obtain fused features, and the fused features assist in generating the high-resolution clear image.

8. The system for processing a low resolution degraded image according to claim 7, wherein, in the processing module, the image restoration branch comprises N restoration convolution modules, a connection module, and N restoration convolution modules sequentially connected; the image super-resolution branch comprises 2N+1 super-resolution convolution modules sequentially connected, wherein the restoration convolution module is a basic operation module that uses convolution operations for restoration tasks, and the super-resolution convolution module is a basic operation module that uses convolution operations for super-resolution tasks;
the i-th fusion module concatenates output features of the i-th module in the image restoration branch, output features of the i-th module in the image super-resolution branch, and output features of the i−1-th fusion module; the concatenated features iterate a preset number of times, and the iteration result is used as the input of the i+1-th fusion module, the input of the i+1-th module in the image restoration branch, and the input of the i+1-th module in the image super-resolution branch, wherein each iteration process involves passing the features through a first convolutional layer, an activation layer, and a second convolutional layer at once; the first fusion module concatenates the output features of the first restoration convolution module, the output features of the first super-resolution convolution module, and the features of the low resolution degraded image.

9. A computer-readable storage medium, characterized in that one or more programs are stored in the computer-readable storage medium, wherein the one or more programs comprises instructions, and the computing device executes the method according to claim 1 when the instructions are executed by a computing device.

10. A computing device, comprising:
one or more processors, a memory, and one or more programs, wherein the one or more programs are stored in the memory and configured to be executed by the one or more processors, and the one or more programs comprising instructions for executing the method according to claim 1.
